(19) United States
(12) Patent Application Publication
(10) Pub. No.: US 2008/0245489 A1
(43) Pub. Date: Oct. 9, 2008

(54) Fabric louver

(76) Inventors: Morgan Hsi-Jung Chuang, Cypress, CA (US); David Pon, Tustin, CA (US)

Correspondence Address: BUCHANAN INGERSOLL & ROONEY PC, P.O. BOX 1404, ALEXANDRIA, VA, 22313-1404, US

(21) Appl. No.: 11/732,535

(22) Filed: Apr. 4, 2007

(51) Int. Cl. E06B 7/08

(52) U.S. Cl. 160/236

(57) ABSTRACT

A fabric louver that has an elongated fabric body that is stretchable along its length is disclosed. The elongated fabric body has a first end and a second end. A first end cap is connected to the first end of the elongated fabric body and a second end cap is connected to the second end of the elongated fabric body. A first key is attached to the first end cap and a second key is attached to the second end cap. The disclosed fabric louver may be connected to the frame of a shutter.

### FIELD OF INVENTION

The invention relates to louvers that can be used in shutters.

### BACKGROUND OF THE INVENTION

Shutters have louvers that extend from one side of a shutter frame, across a window opening, to an opposite side of the shutter frame. The louvers may be oriented horizontally or vertically. The louvers can be rotated from an open position that permits light to pass through the shutter to a closed position at which the louvers block light from passing through the shutter. Typically, a tilt mechanism is coupled to the louvers to permit a user to rotate the louvers from an open position to a closed position. Such tilt mechanisms usually include at least one guide rod coupled to the louvers.

Shutter louvers often have cylindrical pins on each end of the louver that are sized to fit into circular holes in the sides of the shutter frame. Typically, the louvers are rigid along their length and sized to tightly fit within the shutter frame. Due to the rigidity of the louvers and the tight fit the louvers have with the shutter frame, installing louvers in a shutter can often be difficult and time consuming. Similarly, removing louvers from a shutter for cleaning or other maintenance can be a tedious process due to the rigidity of the louvers and the tight fit of the louvers.

It is often necessary to remove the louvers to effectively clean them, particularly if they are made of fabric. Cleaning the louvers can be a time consuming process due to the difficulty of removing the louvers from the shutter and subsequent reinstallation after cleaning. Moreover, because the louvers are rigid along their length, they can be broken or damaged during reinstallation. Often, such damage is caused by bending the rigid louvers during the reinstallation process.

Most louvers are made from wood or plastic. Plastic louvers may be hollow or have a foam core. Wood and plastic louvers can be painted. Apart from a wood grain in a wooden louver, most wood and plastic louvers are a single color throughout and are plain rather than painted or embossed to have a pattern.

Some shutters have fabric louvers that are stretchable about the width of the louvers. Fabric louvers can be woven or painted to have a pattern or be a single color. Fabric louvers can be made to look like wooden or plastic louvers or can look very different from such louvers. Examples of such fabric louvers are disclosed in U.S. Pat. No. 5,775,399 to Shields, Jr. and U.S. Patent Application Publication No. 2005/0269044 to Nien. The louvers of Shields, Jr. and Nien have longitudinal rods that are used to ensure that the fabric louvers appear to be rigid and will not twist about the width of the louver when the louvers are rotated from an open position to a closed position. Such fabric louvers, however, are rigid along their length and are designed to tightly fit within the frame of the shutter. As a result, such fabric louvers can be difficult to install and remove.

Consequently, there is a need for a louver that is easily installed and removed from a shutter frame while also being tightly fitted within the shutter frame. Preferably, such a louver will have a rigid appearance and not twist about its width when the shutter is rotated from an open to a closed position such that the louver is unable to effectively block light that may pass through a window.

### SUMMARY OF THE INVENTION

We provide a fabric louver that has an elongated fabric body that is stretchable along its length. The elongated fabric body has a first end and a second end. A first end cap is connected to the first end of the elongated fabric body and a first key is attached to the first end cap.

In some embodiments, the elongated fabric body can be a tubular body. The elongated fabric body can be made of a plurality of fabric segments or a single segment of fabric. The elongated fabric body may be stretchable along its entire length or only stretchable along one or more portions of its length.

A spring loaded pin may be attached to the first end cap. Moreover, our fabric louver can also have a second end cap attached to the second end of the elongated fabric body and a second key attached to the second end cap. It should be noted that the keys may be seperably connected to the end caps such that the keys are removable from the end caps.

In another embodiment, the fabric louver may have an elongated fabric body that is stretchable along its length and have a first resilient ring attached to its first end. A second resilient ring may also be attached to the second end of the elongated fabric body.

We also provide a shutter. The shutter has a frame and a plurality of fabric louvers connected to the shutter frame. Each fabric louver has an elongated fabric body that is stretchable along its length. The elongated fabric body has a first end and a second end. A first end cap is connected to the first end of the elongated fabric body and a first key is attached to the first end cap. The frame has a hole for each louver of the plurality of louvers that is sized to receive the first key. Each fabric louver is connected to the frame of the shutter such that the first key of each fabric louver is retained in the hole for that fabric louver.

The first end cap can be attached to a stretchable portion of the elongated fabric body or to a non-stretchable portion of the elongated fabric body.

The louvers of the shutter can be connected to the shutter frame so that the louvers are rotatable from an open position to a closed position. The shutter can also include a tilt mechanism that is coupled to the first end cap. The tilt mechanism can be moved in a first direction to rotate the plurality of fabric louvers to the open position and can be moved in a second direction to rotate the plurality of fabric louvers to the closed position. The tilt mechanism may have at least one of a rod, a bar, a rope ladder system, a rack and pinion, or a generally U-shaped body that is coupled to at least one end cap of each louver.

A spring loaded pin can be attached to the first end cap of each fabric louver. The frame may have a recess for each spring loaded pin so that a portion of each spring loaded pin is in one of the recesses. The recesses may be holes, grooves, slots, or other types of apertures or hollows in the frame.

The frame can also have at least one coupling device for attaching the louvers to the frame of the shutter. For such embodiments, the holes in the frame can be in the at least one coupling device. In some embodiments, the at least one coupling device may be a bracket or a swivel bracket.

In other embodiments, our shutter may have a shutter frame and fabric louvers that have an elongated fabric body with a first resilient ring attached to the first end of the elongated fabric body that is retained on the shutter frame.

The shutter frame can have a hole for each fabric louver such that the first resilient ring is retained on the frame by being located adjacent the hole for that louver. In another embodiment, the frame can also house an inner trim piece that has an aperture sized to be smaller than the first resilient ring wherein each louver of the shutter is connected to the first side of the frame such that the first resilient ring is adjacent the aperture for that resilient ring in the inner trim piece. In yet another embodiment, the shutter frame may have at least one coupling device for some or all of the fabric louvers, the holes in the frame being in the at least one coupling device.

The shutter frame can also have a post extending from the frame for each fabric louver. The post has a body and a head, wherein the head of the post has a first section that has a diameter greater than the diameter of the body of the post. The first ring of the fabric louver is located adjacent the first section of the head such that at least a portion of the head of the post is housed within the fabric louver.

It should be noted that our shutters may be attached to or adjacent a window opening or attached to a door. The louvers may also be used in doors, partitions or other similar structures.

Other details, objects and advantages of the invention will become apparent as the following description of certain present preferred embodiments thereof and certain present preferred methods of practicing the same proceeds.

### BRIEF DESCRIPTION OF THE DRAWINGS

In the accompanying drawings we have shown certain present preferred embodiments of the invention and have illustrated certain present preferred methods of practicing the same.

FIG. 1 is a perspective view of a first present preferred embodiment of our shutter having fabric louvers with the louvers being in an open position.

FIG. 2 is a view similar to FIG. 1 with the louvers in a closed position.

FIG. 3 is a front view of a second present preferred embodiment with the louvers in a closed position.

FIG. 4 is a view similar to FIG. 3 with the louvers in an open position.

FIG. 5 is a front view of a third present preferred embodiment with the louvers in a closed position.

FIG. 6 is an exploded view of a first present preferred fabric louver.

FIG. 7 is a sectional view of the louver taken along line VII-VII in FIG. 6.

FIG. 8 is a fragmentary view of a second present preferred fabric louver adjacent a portion of the first side of a shutter frame having a hole and a recess in the first side of the frame to receive the fabric louver.

FIG. 9 is an enlarged view of the hole and the recess in the first side of the frame shown in FIG. 8.

FIG. 10 is a fragmentary view of a key and keyhole that can be used in our shutter having a fabric louver.

FIG. 11 is an exploded view of a third present preferred fabric louver.

FIG. 12 is a fragmentary view of a fourth present preferred fabric louver with dotted lines illustrating an inner trim piece with an aperture housed within the first side of the shutter frame.

FIG. 13 is a sectional view taken along line XIII-XIII in FIG. 12 showing the first resilient ring in dotted lines being adjacent to the hole in the first side of the frame.

FIG. 14 is a view similar to FIG. 13, showing the first resilient ring being in dotted lines being adjacent the aperture in the inner trim piece housed within the first side of the frame.

FIG. 15 is an exploded fragmentary view of a portion of the fourth present preferred fabric louver adjacent the post of the first side of the frame to which the louver will be attached.

FIG. 16 is a perspective view of a portion of the end of the fourth present preferred fabric louver connected to the post such that a portion of the post shown in FIG. 15.

FIG. 17 is a front view of a third present preferred embodiment of our shutter having fabric louvers that do not rotate.

FIG. 18 is a front view of a fourth present preferred embodiment of our shutter wherein the shutter is attached to a door.

FIG. 19 is a front view of a fifth present preferred embodiment with the shutter in a closed position.

### DETAILED DESCRIPTION OF PREFERRED EMBODIMENTS

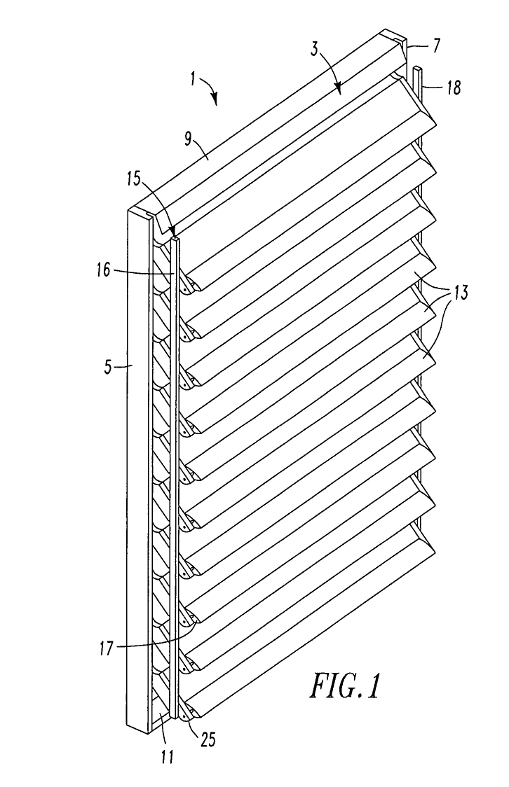

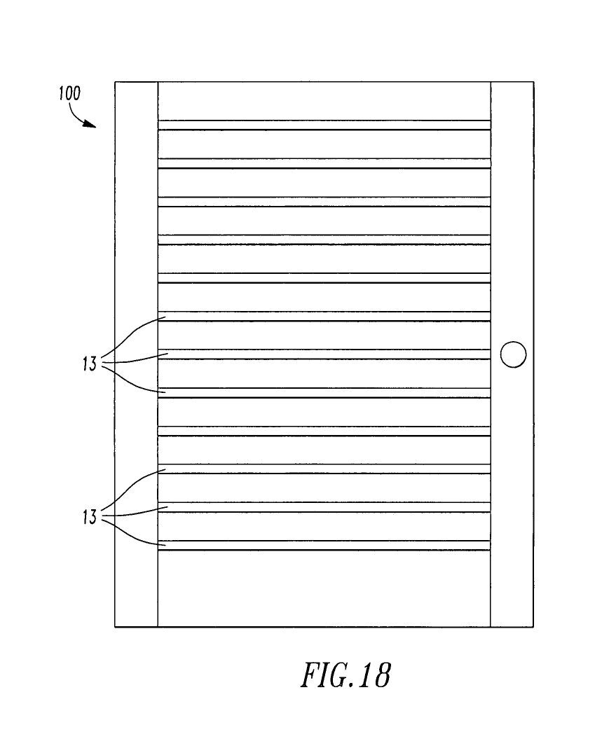

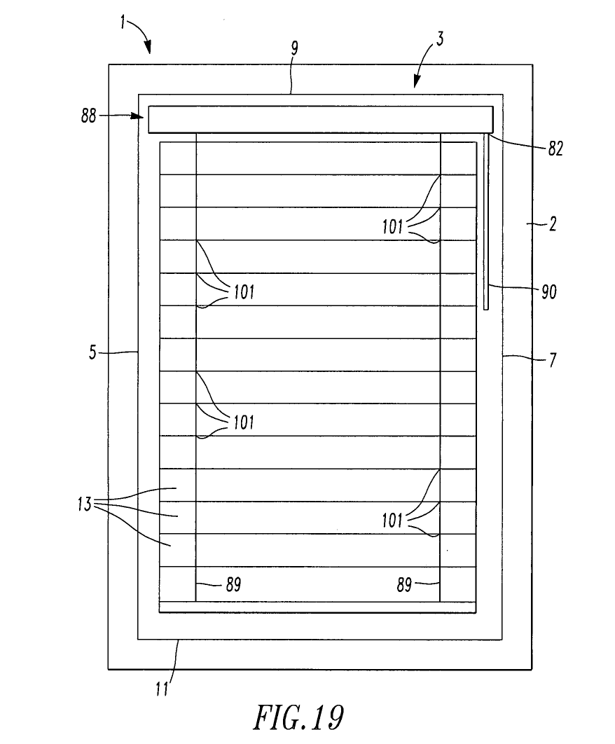

Referring to FIG. 1, shutter 1 has a frame 3 that has a top 9, a bottom 11, a first side 5, and a second side 7. The first side 5 and the second side 7 have couplings 25. A plurality of fabric louvers 13 is connected to the shutter frame. Each fabric louver has a first end cap 17 and a second end cap attached to the ends of the louver. Couplings 25 are attached to each end cap of each louver such that each louver 13 is connected to the first side 5 by a coupling 25 of the first side and is connected to the second side 7 by a coupling of the second side. A tilt mechanism 15 has bars 16, 18 that are attached to the couplings 25 of the first and second sides 5, 7. A first bar 16 is attached to couplings 25 that are attached to the first end cap 17 of the louvers. The second bar 18 is attached to couplings that are attached to the second end cap of the louvers 13. The frame 3 of the shutter may be attached within a door, such as door 100 shown in FIG. 18 or within a window opening.

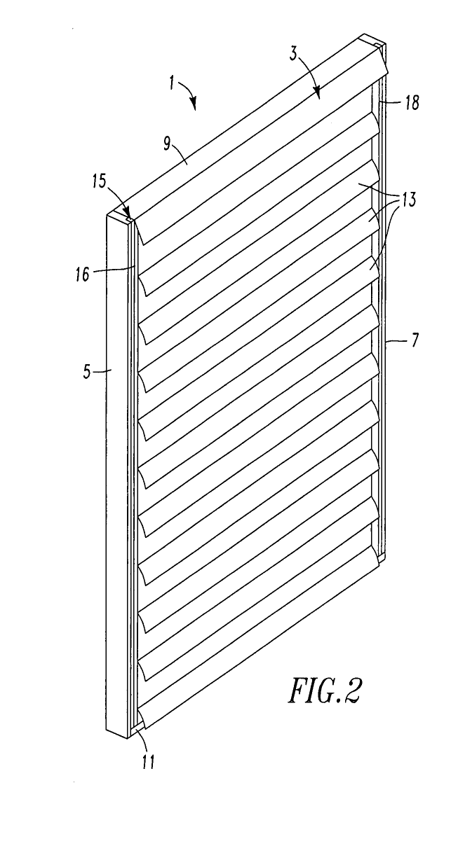

Movement of one bar, such as bar 16, causes the couplings 25, louvers 13 and the other bar 18 to move. Consequently, a user may move bar 16 or bar 18 to open or close the louvers of the shutter. A user may position the bars 16, 18 as shown in FIG. 2 such that the louvers are in a closed position to block light that may emanate from a window opening. If a user desires to permit light to pass through the opening, the user may move bar 16 or 18 away from the shutter, as shown in FIG. 1, such that the louvers are moved to an open position.

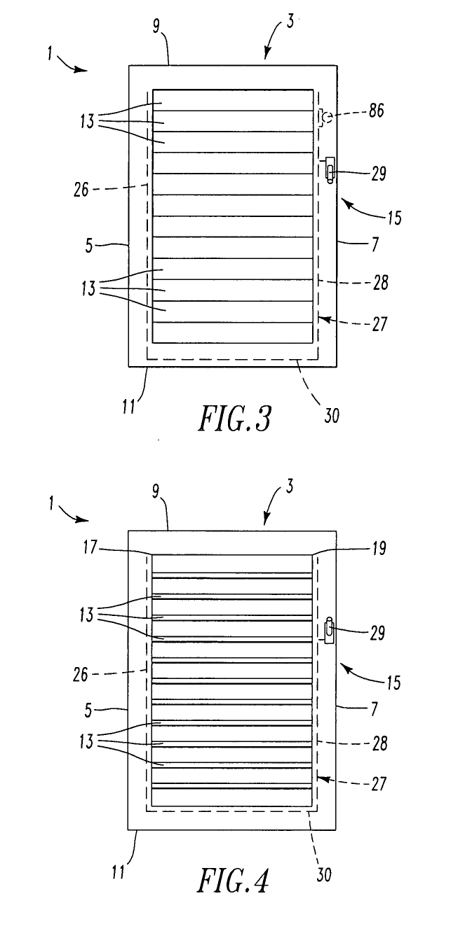

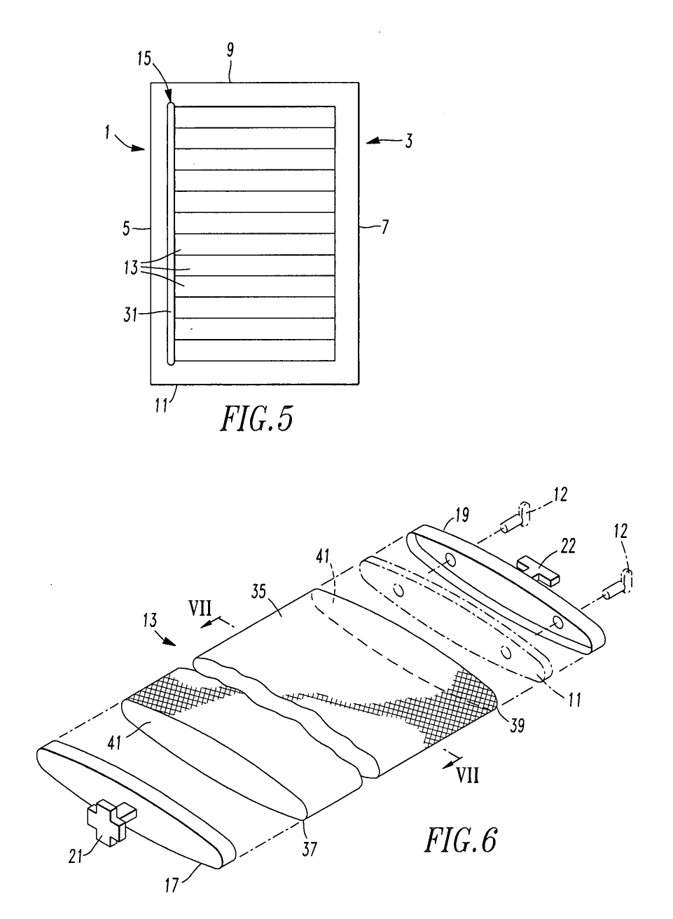

The tilt mechanism 15 may be a rod 31 coupled to the end caps on one end of the louvers, as shown in FIG. 5, such that the rod can be moved up or down to rotate the louvers. The tilt mechanism 15 can also be a generally U-shaped body 27 housed within the shutter frame 3, as shown by dotted lines in FIGS. 3 and 4. The generally U-shaped body 27 has a first vertical member 26 that is connected to a lower member 30 that is attached to a second vertical member 28. The first vertical member 26 of the generally U-shaped body is connected to the first end cap 17 of each louver. The second vertical member 28 of the generally U-shaped body is connected to the second end cap 19 of each louver. The lower member 30 of the generally U-shaped body is located below the louvers. The end caps of the louvers are connected to the vertical members 26, 28 such that movement of the generally U-shaped body 27 can rotate the louvers 13 from an open position to a closed position. In an alternative embodiment, the generally U-shaped body can be configured such that the member 30 attaching the first and second vertical members 26, 28 together is located above the louvers.

It should be understood that the generally U-shaped body can be housed within the frame of the shutter or can be located on the outside of the frame. We prefer to have the generally U-shaped body located within the frame so that the generally U-shaped body is not visible.

The second vertical member 28 can be attached to an operating device or handle 29 that extends from the shutter frame 3. The handle 29 extends from the exterior of the frame 3 of the shutter. Movement of the handle 29 can move the generally U-shaped body to an upward position, as shown in FIG. 4, and to a downward position, as shown in FIG. 3, to place the louvers in an open or closed position. Movement of the handle 29 to an upper position simultaneously moves the generally U-shaped body to an upward position such that the louvers are rotated to an open position. Movement of the handle 29 to a lower position simultaneously moves the generally U-shaped body to a downward position, which rotates the louvers 13 to a closed position.

The handle 29 may be an L-shaped body that is welded to the second vertical member 28 or first vertical member 26 of the generally U-shaped body or may be a rod or bar that is coupled to the generally U-shaped body. Of course, the operating device can also be other structures known to those skilled in the art that can be connected to the generally U-shaped body 27 such that the operating device can move the generally U-shaped body to the upward or downward position to open and close the shutter. For example, the operating device can be a rack and pinion system 86 coupled to a vertical member 28 shown by dotted lines in FIG. 3. The pinion may be part of a dial or coupled to a dial such that rotation of the dial causes the pinion to rotate. The pinion has teeth that intermesh with teeth on a rack that may be coupled to the vertical member 27 or may be located directly on at least a portion of the vertical member such that rotation of the dial causes the member to move upwards or downwards, causing the louvers of the shutter to rotate from an open position to a closed position. Of course, such a rack and pinion system may also be utilized in connection with other tilt mechanisms, such as one including rod 31 shown in FIG. 5.

In yet another embodiment, the tilt mechanism may be a rope ladder system 88 similar to those used in venetian blinds, as shown in FIG. 19. The rope ladder system includes a plurality of cords 89 that extend from a shaft 82 located above the louvers 13 of the shutter. The rungs of the rope ladder extend from cords 89 such that the rungs 101 of the rope ladder are positioned below each louver of the shutter. The rope ladders should be aligned over that portion of the end caps of the louvers which extends into the tubular fabric body. The end caps may have a notch 87 or hole, as shown by dotted lines in FIG. 8. The notch is sized to receive at least a portion of the rope ladder positioned below each louver. The end caps provide additional support for the rope ladder making it easier to tilt the louvers. Further, the rope ladder may be less noticeable when located adjacent the end caps. An operating device, such as a wand 90, is coupled to the shaft such that rotation of the wand causes the rope ladders to tilt, which causes the louvers to rotate between an open position and a closed position.

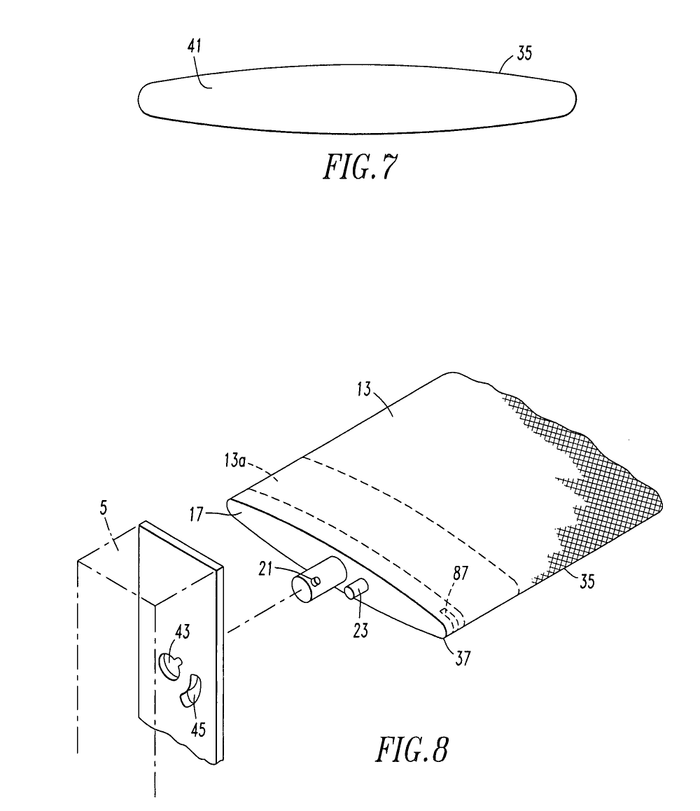

A fabric louver that may be used in the shutter of the first, second, or third present preferred embodiments shown in FIGS. 1-5 is illustrated in FIG. 6. The fabric louver 13 has an elongated tubular fabric body 35 that is stretchable along its length. The elongated tubular fabric body has a first end 37 and a second end 39. As best seen in FIG. 7, the elongated tubular fabric body has a hollow center 41 that extends from the first end 37 to the second end 39. A first end cap 17 is attached to the first end 37 of the elongated tubular fabric body and a second end cap 19 is attached to the second end 39 of the elongated tubular fabric body. A first key 21 is attached to the first end cap 17 and is sized to fit within a hole in the first side 5 of the shutter frame. A second key 22 is attached to the second end cap 19 and is sized to fit within a hole in the second side 7 of the shutter frame. The first key 21 and the second key 22 may have different shapes, as illustrated in FIG. 6, or have the same structure.

Keys 21, 22 may be connected to the end caps such that the keys are removable from the end caps. It should be understood that the separable connection of keys 21, 22 to the end caps permits the louver to be customized for fitting within shutters sized to cover various sized windows.

One can provide a tension adjustment to changed the tension along the length of the louver. One way this can be done is to make end cap 19 hollow and provide an intermediate end cap 11 shown in FIG. 6 in dotted line. The fabric body 35 is attached to the intermediate end cap 11. That intermediate end cap fits into end cap 19. Screws 12 run through unthreaded hole in end cap 19 into threaded holes in intermediate end cap 11. By turning the screws 12 one can draw intermediate end cap 11 into end cap 19 increasing the tension along the length of the fabric body.

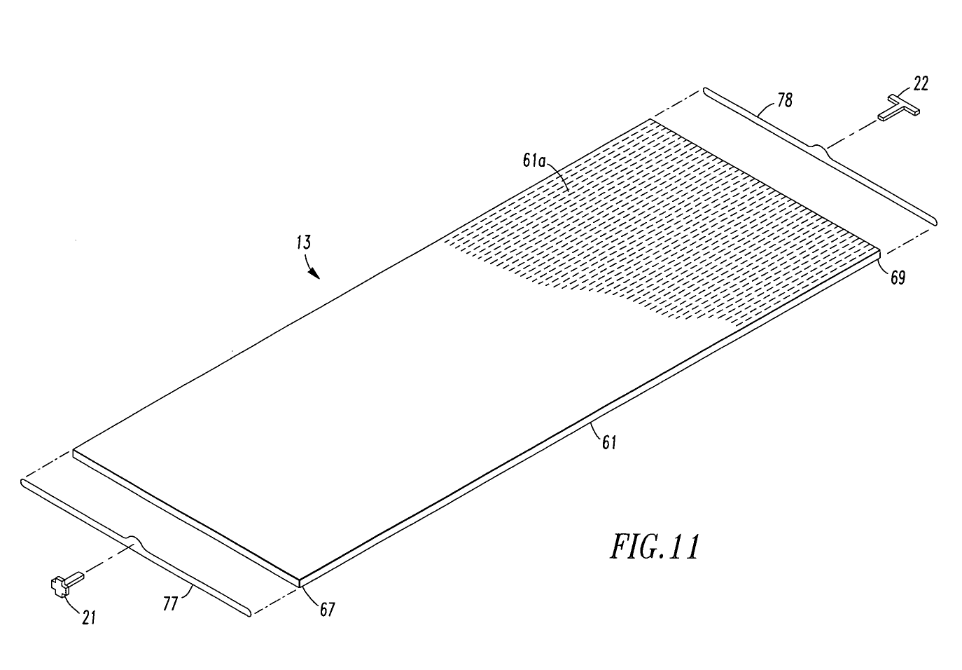

In another present preferred embodiment, the fabric louver 13 can have an elongated body 61 that is not tubular, as shown in FIG. 11. Such an elongated body 61 can be a stretchable ribbon, or a series of parallel ribbons or strings that can stretch in a longitudinal direction. A portion of such parallel ribbons or strings 61a is shown in dotted line in FIG. 11. The elongated body 61 has a first end 67 and a second end 69. A first end cap 77 is attached to the first end 67 and a second end cap 78 is attached to the second end 69. A first key 21 is attached to the first end cap 77 and a second key 22 is attached to the second end cap 78. Of course, the keys 21, 22 may be attached such that the keys are removable from the end caps.

The fabric louver 13 is attached to the frame of a shutter by fitting keys 21, 22 into holes sized to receive the keys of the louver. The holes can be located in the first and second sides 5, 7 of the frame or in coupling devices 25 attached to the first side 5 and second side 7 of the shutter frame. The holes in the frame of the shutter are configured to receive and releasably retain the keys 21, 22 of each louver such that the keys 21, 22 can be locked in place by each hole. Such locking results from the unique shape of the keys and their respective holes.

In a fifth present preferred embodiment, shown in FIG. 8, hole 43 in the first side 5 of the frame is sized to allow first key 21, a portion of which has a generally L-shaped cross-section, to fit within the hole 43 so that the louver may be connected to the frame of the shutter. After the first key 21 is inserted into the hole 43, the louver is rotated to turn the first key 21 so that the L-portion of the first key 21 is locked in the hole 43 and cannot be pulled out of the hole 43. It should be understood that there is also a hole in the second side 7 of the shutter frame that is sized to receive second key 22 of the louver. Second key 22 is, similarly to the first key 21, inserted into the hole in the second side 7 of the frame and locked therein. The louver is stretchable in its longitudinal direction and has a length in a relaxed condition which is somewhat less than the opening into which the shutter is placed. Consequently, the louver must be stretched to install the louver in the shutter frame. Keys 21 and 22 retain the ends of the louver within their respective holes such that the louver is connected to the frame and able to rotate from an open position to a closed position. In an alternative embodiment, such holes are in the coupling devices 25 of the first and second sides 5, 7 of the frame instead of directly in the sides of the frame, an example of such a hole being illustrated in FIG. 10.

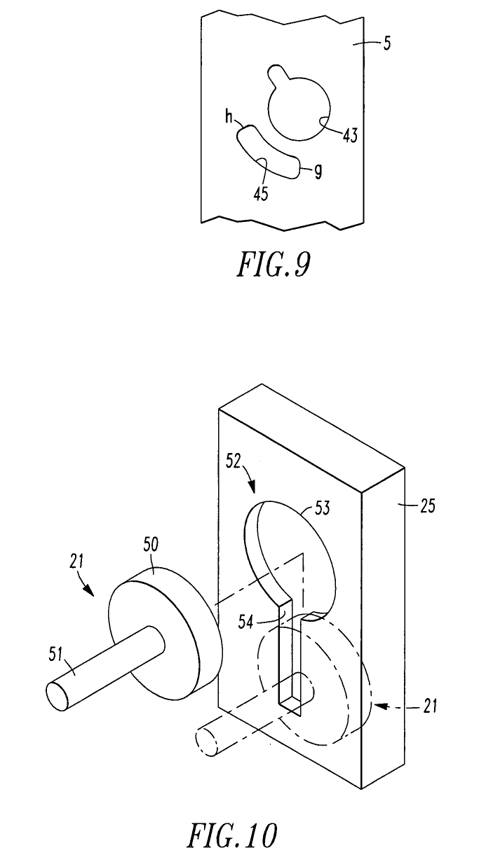

A spring loaded pin 23 may also be attached to at least one of the end caps of the louver to help ensure the louver stays connected to the shutter frame. As best seen in FIGS. 8 and 9, a spring loaded pin 23 is attached to the first end cap 17 of the fabric louver 13. The spring loaded pin is inserted into recess 45 in the first side 5 of the shutter frame so that a portion of the pin is inside the recess 45. The recess 45 is sized so that the pin 23 can move from a first position g, which corresponds with the closed position of the louver, to a second position h, which corresponds with the open position of the louver. Positions g and h are configured so that the pin 23 prevents the louver from being rotated to a position at which the first key 21 is aligned with the hole 43 such that the memory of the fabric can pull the end of the louver out of the hole 43. A user can compress the spring loaded pin 23 to permit the louver to be rotated to align the first key 21 with the hole 43 so the end of the louver can be removed from the hole 43. Consequently, the spring loaded pin 23 helps ensure the louvers stay connected to the shutter frame as the louvers are rotated to open and closed positions without preventing the louvers from being easily removed for cleaning or other maintenance by a user.

Keys 21, 22 can have numerous different shapes and sizes that can fit within corresponding shapes and sizes of holes 43 in the first and second sides of shutter frames. The keys may also be sized such that there is a thick portion 50 and a thin portion 51 that can fit within a hole 52, as shown in FIG. 10. The hole 52 has a large opening 53 sized to receive the thick portion 50 of the key and has an elongated narrow opening 54 below the large opening 53 that is sized to receive the thin portion 51 of the key. As a result, the first key 21 can be inserted into the large opening 53 of the hole and subsequently slid into the elongated narrow opening 54 to lock the first key 21 in the hole 52. The key may be easily removed from the hole 53 by raising the louver to a height that brings the thick portion 50 of the key into alignment with the large portion 53 of the hole and then sliding the key out of the hole.

Because the louver may be stretched along its length, the louver may be sized to easily fit within the frame of the shutter prior to stretching the louver to insert and lock the keys 21, 22, within their respective holes in the first and second sides 5, 7 of the frame. Preferably, once the stretched louvers are connected to the first and second sides 5, 7 of the shutter, they will be tightly fit within the frame of the shutter.

Locking of keys 21, 22 in their respective holes in the first side and second side 5, 7 of the shutter frame keeps the louver stretched to tightly fit within the shutter frame such that the louver 13 is rigid. The force provided by the memory of the fabric not only keeps the ends of the louvers in the frame, but also prevents the elongated fabric body from twisting about its width when the louver is rotated. When louvers made of such fabric are used, removal of the louvers from the shutter causes the louvers to shrink back to its unstretched length.

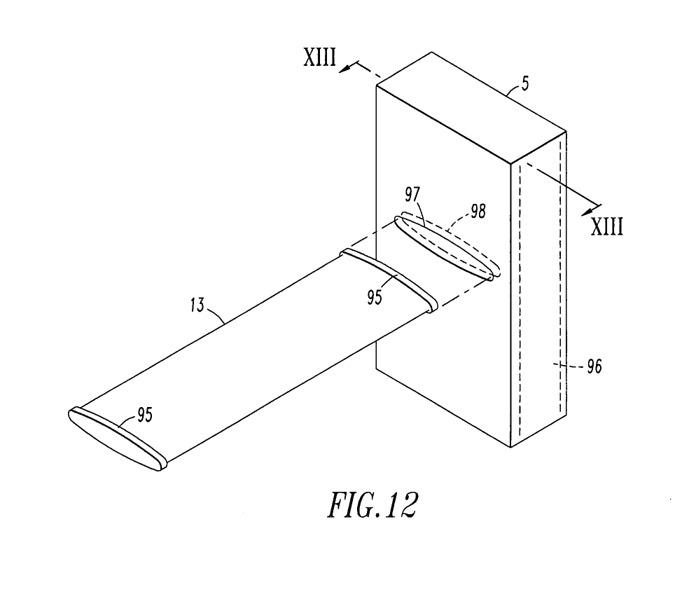

The louver 13 may also have resilient members, such as resilient ring 95, connected to at least one of the first end and second end of the louver, as shown in FIG. 12. The elasticity of the ring and flexibility of the fabric permits a user to alter the size of the ring such that the ring can fit within apertures of smaller size and, once inserted within the hole, expand to its original shape. Similarly, the resiliency of the ring may permit the ring to be stretched to permit the louver to be fitted over a larger head on a post or similar structure that the end of the object is retained on the post by the ring.

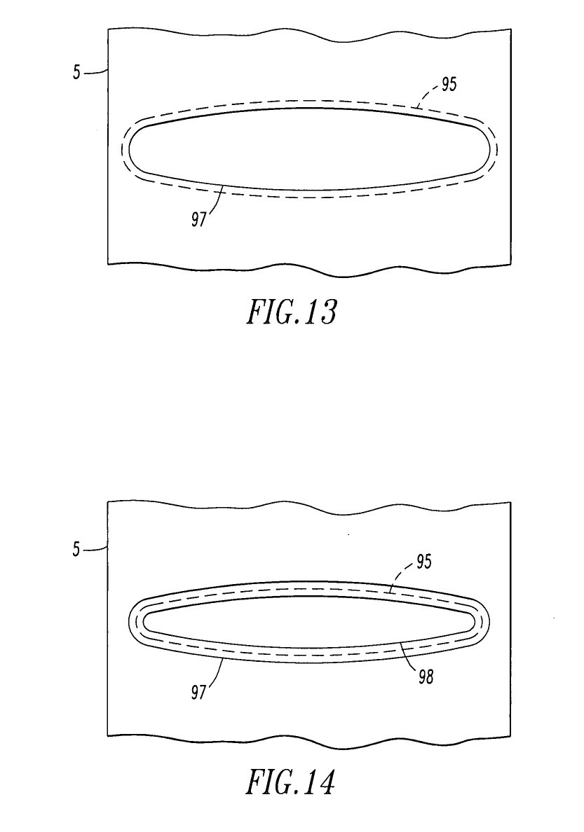

Referring to FIGS. 12-14, louver 13 with resilient rings 95 attached to the first and second ends of the louver may be attached to the sides of a shutter frame by inserting the resilient rings into hole 97 in the sides of the frame. An installer may manipulate the ring to permit the ring to pass through the smaller sized hole 97. After the ring has passed through the hole 97, the ring returns to its original shape so that the ring is adjacent the hole 97 and abuts the side of the frame along the perimeter of the hole 97, as shown by dotted lines in FIG. 13. In this way, the end of the louver is connected to the shutter frame. In an alternative embodiment, shown by dotted lines in FIG. 12 and 14, the resilient ring may be inserted through a larger opening 97 in the frame of the shutter and manipulated to pass through a smaller hole 98 in an inner trim piece 96 located within the side 5 of the frame. The memory of the ring material returns the ring to its original size such that the ring is adjacent hole 98. The ring then abuts the inner trim piece 96 such that the ring is interlocked with the side 5 of the frame, as shown by dotted lines in FIG. 14.

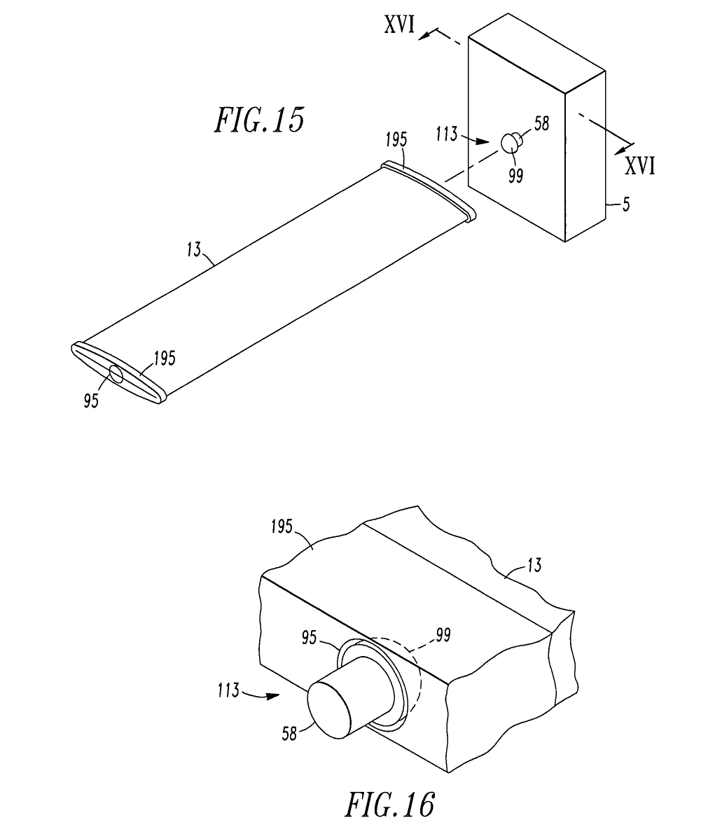

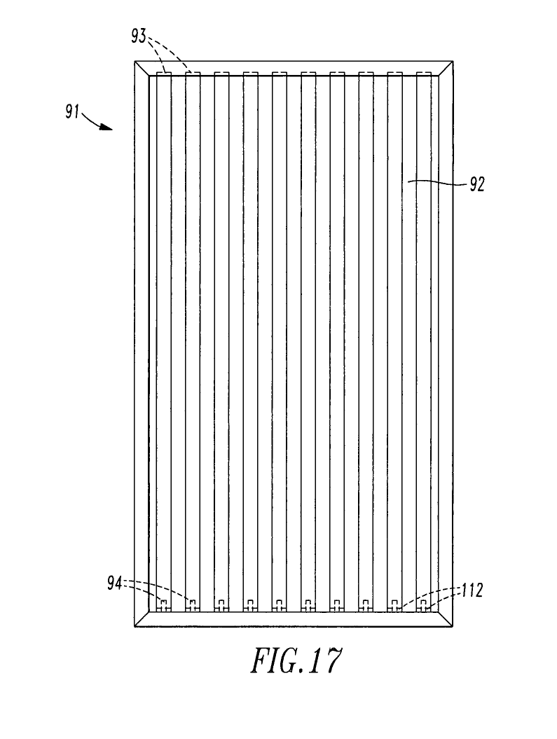

Referring to FIG. 15, the louver 13 has ends 195, each end having a resilient ring 95. The resilient ring fits over a mushroom shaped post 113 on the frame. At least a portion of the head 99 of the post 113 has a larger diameter than the body 58 of the post. The resilient ring 95 is be stretched by an installer to fit over the head and be retained on the post, interlocking the louver with the side 5 of the frame, as best seen in FIG. 16. While resilient ring 95 has been shown and described as a generally circular shaped object, the ring 95 may also be configured in the shape of rectangles, other polygons and other rounded shapes.

The fabric louver 13 may be made of one segment of fabric or a plurality of fabric segments. The fabric segments can be the same material or different materials. For embodiments in which each fabric segment of the elongated body of the louver does not extend from one end of the elongated body to the other end of the elongated body, it should be understood that only one of the fabric segments must be stretchable in a longitudinal direction of the louver. For example, fabric segment 13a in FIG. 8 is stretchable along the longitudinal direction of the louver while other portions of the louver do not stretch in that direction.

The louvers may be used in vertical shutters that do not rotate, such as vertical shutter 91 shown in FIG. 17. The louvers 92 have a first end 93 that is interlocked within a mating hole located in the top of the shutter frame. The body of the louver extends from the first end to the second end. The second end of the louver may be hollow such that the second end encircles a post 94 that extends from the bottom of the shutter frame. In an alternative embodiment, a resilient ring may be attached to the second end of the louver to ensure the second end of the louver keeps its position surrounding the post and stays fully extended from the top of the shutter frame to the bottom of the shutter frame. Of course, the second end could also be attached to the post by welding, adhesives, or other means known to those skilled in the art. Alternatively, a weight 112 may be connected to the second end of the louver to ensure the louver stretches along its length and stays positioned around post 94, as shown in dotted line in FIG. 17. Of course, it should be understood that such shutters can also be configured to rotate from an open to a closed position.

While we have shown and described certain present preferred embodiments of the invention and have illustrated certain present preferred methods of practicing the same, it is to be distinctly understood that the invention is not limited thereto but may be otherwise variously embodied and practiced within the scope of the following claims.

We claim:

1. A fabric louver for shutters comprising:
an elongated fabric body, the elongated fabric body having a first end and a second end, the elongated fabric body being stretchable along its length;
a first end cap connected to the first end of the elongated fabric body; and
a first key attached to the first end cap.

2. The fabric louver of claim 1 wherein the elongated fabric body is stretchable along its entire length.

3. The fabric louver of claim 1 also comprising a spring loaded pin, the spring loaded pin being attached to the first end cap.

4. The fabric louver of claim 1 wherein the elongated fabric body is comprised of a first portion which is stretchable and a second portion which is not stretchable.

5. The fabric louver of claim 1 wherein the elongated fabric body is comprised of a plurality of fabric segments, a plurality of strings, or a plurality of parallel ribbons.

6. The fabric louver of claim 1 wherein the elongated fabric body is an elongated tubular fabric body.

7. The fabric louver of claim 1 further comprised of a second end cap connected to the second end of the elongated fabric body and a second key attached to the second end cap.

8. The fabric louver of claim 1 wherein the first key is separably connected to the first end cap.

9. The fabric louver of claim 1 also comprising a tension adjustment within the louver for changing tension in the elongated fabric body along its length.

10. A shutter comprising:
a plurality of fabric louvers, each fabric louver being comprised of an elongated fabric body, the elongated fabric body having a first end and a second end the elongated fabric body being stretchable along its length, a first end cap connected to the first end of the elongated fabric body and a first key attached to the first end cap;
a frame, the frame having a hole for each louver, the hole being sized to receive the first key; and
wherein each fabric louver is connected to the frame such that the first key of each fabric louver is retained in the hole for that fabric louver.

11. The shutter of claim 10 wherein the elongated fabric body has a stretchable portion and a portion which does not stretch in a longitudinal direction and the first end cap is attached to the stretchable portion of the elongated fabric body.

12. The shutter of claim 10 wherein each fabric louver of the plurality of fabric louvers is further comprised of a second end cap connected to the second end of the elongated fabric body and a second key attached to the second end cap and wherein the frame has an aperture for each second key sized to receive the second key, wherein each fabric louver is connected to the frame such that the second key of each fabric louver is retained in the aperture for that second key.

13. The shutter of claim 10 wherein the first key of each fabric louver fits within the holes of the shutter frame such that each fabric louver may rotate from an open position to a closed position.

14. The shutter of claim 10 further comprising a tilt mechanism, the tilt mechanism being coupled to the first end cap, wherein the tilt mechanism can be moved in a first direction to rotate the plurality of fabric louvers to the open position and the tilt mechanism can be moved in a second direction to rotate the plurality of fabric louvers to the closed position.

15. The shutter of claim 14 wherein the tilt mechanism is comprised of one of a rod, a bar, a rope ladder, a rack and pinion, and a generally U-shaped body.

16. The shutter of claim 10 also comprising a spring loaded pin attached to the first end cap of each of the plurality of fabric louvers.

17. The shutter of claim 16, wherein the frame has a recess for each spring loaded pin and a portion of each spring loaded pin is in one of the recesses.

18. The shutter of claim 10 wherein the elongated fabric body is stretchable along its entire length.

19. The shutter of claim 10 wherein the elongated fabric body is comprised of a plurality of fabric segments, a plurality of strings, or a plurality of parallel ribbons.

20. The shutter of claim 10 wherein the frame is further comprised of at least one coupling device attached to the frame, wherein the hole is in the at least one coupling device.

21. The shutter of claim 10 wherein the elongated fabric body is an elongated tubular fabric body.

22. The shutter of claim 10 further comprised of a door wherein the frame is attached to the door.

23. A fabric louver for shutters comprising:
an elongated fabric body, the elongated fabric body having a first end and a second end, the elongated fabric body being stretchable along its length; and
a first resilient ring connected to the first end of the elongated fabric body.

24. The fabric louver of claim 23 wherein the elongated fabric body is stretchable along its entire length.

25. The fabric louver of claim 23 wherein the elongated fabric body is comprised of a first portion which is stretchable and a second portion which is not stretchable.

26. The fabric louver of claim 23 wherein the elongated fabric body is comprised of a plurality of fabric segments, a plurality of strings, or a plurality of parallel ribbons.

27. The fabric louver of claim 23 wherein the elongated fabric body is an elongated tubular fabric body.

28. The fabric louver of claim 23 further comprised of a second resilient ring connected to the second end of the elongated fabric body.

29. A shutter comprising:
a frame configured to receive and retain a plurality of fabric louvers, and
a plurality of fabric louvers, each fabric louver being comprised of an elongated fabric body, the elongated fabric body having a first end and a second end, the elongated fabric body being stretchable along its length, and a first resilient ring connected to the first end of the elongated fabric body, the first resilient ring of each fabric louver being retained on the frame.

30. The shutter of claim 29 wherein the first side of the frame of the shutter is further comprised of a hole for each fabric louver of the plurality of fabric louvers, and wherein the first resilient ring of each fabric louver of the plurality of fabric louvers is retained on the frame such that the first resilient ring is adjacent the hole for that louver.

31. The shutter of claim 30 wherein the frame is further comprised of at least one coupling device attached to the frame, wherein the hole is in the at least one coupling device.

32. The shutter of claim 29 wherein the frame has a hole for each fabric louver, the shutter further comprising an inner trim piece housed within the frame, the inner trim piece having an aperture sized smaller than the first resilient ring for each fabric louver of the plurality of fabric louvers, and wherein each fabric louver is connected to the frame such that a portion of each fabric louver extends through the hole for that louver and the first resilient ring of each fabric louver of the plurality of fabric louvers is retained on the frame such that the first resilient ring of each fabric louver is adjacent the aperture for that louver.

33. The shutter of claim 29 wherein the frame of the shutter is further comprised of a post for each fabric louver of the plurality of fabric louvers, each post having a head and a body, the head of the post having a first section, the first section of the head having a diameter that is greater than the diameter of the body of the post, and wherein each fabric louver is connected to the frame such that the first resilient ring is located adjacent the first section of the head of the post such that at least a portion of the head of the post is housed within the fabric louver.

34. The shutter of claim 29 wherein each fabric louver of the plurality of fabric louvers is further comprised of a second resilient ring connected to the second end of the elongated fabric body.

35. The shutter of claim 29 further comprising a tilt mechanism, the tilt mechanism being coupled to the first end of the elongated fabric body, wherein the tilt mechanism can be moved in a first direction to rotate the plurality of fabric louvers to the open position and the tilt mechanism can be moved in a second direction to rotate the plurality of fabric louvers to the closed position.

36. The shutter of claim 35 wherein the tilt mechanism is comprised of one of a rod, a bar, a rope ladder, a rack and pinion, and a generally U-shaped body.

37. The shutter of claim 29 wherein the elongated fabric body is stretchable along its entire length.

38. The shutter of claim 29 wherein the elongated fabric body is comprised of a plurality of fabric segments, a plurality of strings, or a plurality of parallel ribbons.

39. The shutter of claim 29 further comprised of a door wherein the frame of the shutter is attached to the door.
